(19) United States
(12) Patent Application Publication
(10) Pub. No.: US 2009/0088512 A1
(43) Pub. Date: Apr. 2, 2009

(54) Flame-retardant compounded polyester materials

(75) Inventors: Elke Schlosser, Augsburg (DE); Sebastian Hoerold, Diedorf (DE); Ute Schwarz, Rudolstadt (DE); Stefan Reinemann, Rudolstadt (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/231,237

(22) Filed: Aug. 29, 2008

(30) Foreign Application Priority Data
Sep. 1, 2007 (DE) 10 2007 041 594.1

(51) Int. Cl. C08K 3/34; C08L 69/00; C08K 3/40

(52) U.S. Cl. 524/447; 524/537; 524/451; 524/449

(57) ABSTRACT

The invention relates to flame-retardant compounded polyester materials, comprising as component A, from 40 to 64.9% by weight of thermoplastic polyester, as component B, from 5 to 10% by weight of polycarbonate, as component C, from 10 to 15% by weight of phosphinic salt of the formula (I) and/or diphosphinic salt of the formula (II), and/or polymers of these

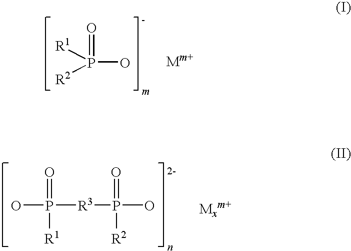

in which
R¹ and R² are identical or different and are H or C₁-C₆-alkyl, linear or branched, and/or aryl;
R³ is C₁-C₁₀-alkylene, linear or branched, C₆-C₁₀-arylene, or -alkylarylene, or -arylalkylene;
M is Mg, Ca, Al, Sb, Sn, Ge, Ti, Fe, Zr, Ce, Bi, Sr, Mn, Li, Na, K, and/or a protonated nitrogen base;
m is from 1 to 4; n is from 1 to 4; and x is from 1 to 4,
   as component D, from 5 to 10% by weight of melamine polyphosphate, as component E, from 15 to 30% by weight of reinforcing materials, and, as component F, from 0.1 to 2% by weight of further additives, where the total of the components by weight is 100% by weight.

The present invention flame-retardant compounded polyester materials herein.

The invention relates to flame-retardant compounded polyester materials with improved fire properties and with excellent mechanical properties.

The chemical constitution of many plastics makes them readily combustible. Plastics therefore generally have to be equipped with flame retardants, in order to allow achievement of the stringent flame retardancy requirements demanded by plastics processors and to some extent also by legislation. A wide variety of flame retardants and of flame retardant synergists is known for this purpose and is also commercially available.

For some time, preference has been given to use of non-halogenated flame retardant systems, because they have more advantageous ancillary properties in the event of a fire in relation to the density and constitution of smoke, and for environmental reasons. Among the non-halogenated flame retardants, the salts of phosphinic acids (phosphinates) have proven particularly effective for thermoplastic polyesters (DE-A-2 252 258 and DE-A-2 447 727). Calcium phosphinates and aluminum phosphinates have been described as very effective in polyesters, and give less impairment of the properties of the polymer molding composition materials than do the alkali metal salts, for example (EP-A-0 699 708).

Synergistic combinations of phosphinates with various nitrogen-containing compounds have moreover been found, and are more effective as flame retardants than the phosphinates alone in a large number of polymers (PCT/EP 97/01664, DE-A-197 34 437, DE-A-197 37 727, and U.S. Pat. No. 6,255,371).

WO2005/059 018 describes a polybutylene terephthalate with a nitrogen-containing flame retardant, with a phosphinate, and with a charring polymer. Charring polymers here are polyetherimides, polyphenylene ethers, polyphenylene sulfide, polysulfones, polyether sulfones, polyphenylene sulfide oxides, or phenolic resins. Addition of the charring polymer improves flame retardancy. A disadvantage of the additives used in that publication is the high price of the charring polymers, and also their tendency to cause discoloration phenomena.

DE 10 2005 050956 describes thermoplastic molding compositions composed of a polybutylene terephthalate and of a polyester other than polybutylene terephthalate, and also describes phosphinates and a reaction product derived from a nitrogen-containing compound with phosphoric acid. Polyethylene terephthalates (PET) and polytrimethylene terephthalates are preferred. Addition of PET achieves UL 94 V-0, and also good tracking resistance, and good mechanical properties. A GWIT of 775° C. to IEC 60695-2-13 is achieved using material of thickness 1.5 mm.

When the phosphinates are used alone or in combination with other flame retardants in polyesters there is generally some degree of polymer degradation, and this has an adverse effect on the mechanical properties of the polymer system.

Another disadvantage is unreliable UL 94 V-0 classifications caused by excessive afterflame times of individual test specimens, a lack of reliable GWIT 775° C. classification at low wall thicknesses (<1.5 mm), and values below 2% for tensile strain at break, in particular for glass (fiber) contents of from 25 to 35%.

Surprisingly, it has now been found that addition of polycarbonates to polyesters, in particular to polybutylene terephthalate, and a flame retardant combination based on phosphinates can produce flame-retardant compounded polyester materials which feature a reliable UL 94 V-0 classification, increased glow-wire resistance, improved mechanical properties, and reduced polymer degradation.

The invention therefore provides flame-retardant compounded polyester materials, comprising, as component A, from 40 to 64.9% by weight of thermoplastic polyester, as component B, from 5 to 10% by weight of polycarbonate, as component C, from 10 to 15% by weight of phosphinic salt of the formula (I) and/or diphosphinic salt of the formula (II), and/or polymers of these

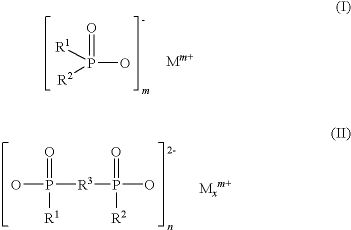

in which
R¹ and R² are identical or different and are H or C₁-C₆-alkyl, linear or branched, and/or aryl;
R³ is C₁-C₁₀-alkylene, linear or branched, C₆-C₁₀-arylene, or -alkylarylene, or -arylalkylene;
M is Mg, Ca, Al, Sb, Sn, Ge, Ti, Fe, Zr, Ce, Bi, Sr, Mn, Li, Na, K, and/or a protonated nitrogen base;
m is from 1 to 4; n is from 1 to 4; and x is from 1 to 4,
as component D, from 5 to 10% by weight of melamine polyphosphates, as component E, from 15 to 30% by weight of reinforcing materials, and, as component F, from 0.1 to 2% by weight of further additives, where the total of the components by weight is 100% by weight.

It is particularly preferable that R¹ and R² are identical or different and are methyl, ethyl, n-propyl, isopropyl, n-butyl, tert-butyl, n-pentyl, and/or phenyl.

It is preferable that R³ is methylene, ethylene, n-propylene, isopropylene, n-butylene, tert-butylene, n-pentylene, n-octylene, or n-dodecylene; phenylene or naphthylene; methylphenylene, ethylphenylene, tert-butylphenylene, methylnaphthylene, ethylnaphthylene, or tert-butylnaphthylene; phenylmethylene, phenylethylene, phenylpropylene, or phenylbutylene.

It is preferable that component E is mineral particulate fillers based on talc, mica, silicate, quartz, titanium dioxide, wollastonite, kaolin, amorphous silicas, magnesium carbonate, chalk, feldspar, and/or barium sulfate.

It is particularly preferable that component E is glass fibers.

It is preferable that the flame-retardant compounded polyester materials further comprise carbodiimides.

It is preferable that component F is lubricants and/or mold-release agents.

The lubricants and/or mold-release agents are preferably long-chain fatty acids, salts thereof, ester derivatives and/or amide derivatives thereof, montan waxes, and/or low-molecular-weight polyethylene waxes and/or low-molecular-weight polypropylene waxes.

The invention also provides a process for the production of the inventive compounded flame-retardant polyester materials, which comprises mixing components A to F in the proportions by weight mentioned, via melt extrusion.

The invention moreover provides fibers, foils, and moldings composed of the flame-retardant compounded polyester materials as claimed in one or more of claims 1 to 7.

Finally, the invention provides the use of the fibers, foils, and moldings composed of the inventive flame-retardant compounded polyester materials as claimed in claim 9 in households, in industry, in medicine, in motor vehicles, in aircraft, in ships, or in spacecraft, or else in other means of conveyance, in office equipment, or else in articles and buildings requiring a relatively high level of fire protection.

It is preferable that M is magnesium, calcium, aluminum, or zinc, particularly aluminum or zinc.

It is preferable that m is 2 or 3; and that n is 1 or 3; and that x is 1 or 2.

The thermoplastic polyesters (component A) are those selected from the group of the polyalkylene terephthalates. Polyalkylene terephthalates for the purposes of the invention are reaction products derived from aromatic dicarboxylic acids or from their reactive derivatives (e.g. dimethyl esters or anhydrides) and from aliphatic, cycloaliphatic, or araliphatic diols, or are a mixture of these reaction products.

Polyalkylene terephthalates preferred according to the invention can be produced from terephthalic acid (or from its reactive derivatives) and from aliphatic or cycloaliphatic diols having from 2 to 10 carbon atoms, by known methods (Kunststoff-Handbuch [Plastics Handbook], vol. VIII, pp. 695-710, Karl-Hanser-Verlag, Munich 1973).

Polyalkylene terephthalates to be used with preference according to the invention contain, based on the dicarboxylic acid, at least 80 mol %, preferably 90 mol %, of terephthalic acid radicals.

The polyalkylene terephthalates to be used with preference according to the invention can contain not only terephthalic acid radicals but also up to 20 mol % of radicals of other aromatic dicarboxylic acids having from 8 to 14 carbon atoms, or radicals of aliphatic dicarboxylic acids having from 4 to 12 carbon atoms, examples being radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid.

The polyalkylene terephthalates to be used according to the invention can be branched via incorporation of relatively small amounts of tri- or tetrahydric alcohols, or of tri- or tetrabasic carboxylic acids, these being as described in DE-A-19 00 270. Examples of preferred branching agents are trimesic acid, trimellitic acid, trimethylolethane, and trimethylolpropane, and pentaerythritol.

According to the invention, particular preference is given to polyalkylene terephthalates prepared solely of terephthalic acid and of its reactive derivatives (e.g. its dialkyl esters) and ethylene glycol and/or 1,3-propanediol and/or 1,4-butanediol (polyethylene terephthalate, polytrimethylene terephthalate, and polybutylene terephthalate), and to mixtures of these polyalkylene terephthalates.

Preferred polybutylene terephthalates contain, based on the dicarboxylic acid, at least 80 mol %, preferably 90 mol %, of terephthalic acid radicals and, based on the diol component, at least 80 mol %, preferably at least 90 mol %, of 1,4-butanediol radicals.

The preferred polybutylene terephthalates can moreover contain, alongside 1,4-butanediol radicals, up to 20 mol % of other aliphatic diols having from 2 to 12 carbon atoms, or of cycloaliphatic diols having from 6 to 21 carbon atoms, examples being radicals of ethylene glycol, 1,3-propanediol, 2-ethyl-1,3-propanediol, neopentyl glycol, 1,5-pentanediol, 1,6-hexanediol, 1,4-cyclohexanedimethanol, 3-methyl-2,4-pentanediol, 2-methyl-2,4-pentanediol, 2,2,4-trimethyl-1,3-pentanediol, 2-ethyl-1,3-hexanediol, 2-ethyl-1,6-hexanediol, 2,2-diethyl-1,3-propanediol, 2,5-hexanediol, 1,4-di([beta]hydroxyethoxy)benzene, 2,2-bis(4-hydroxycyclohexyl)propane, 2,4-dihydroxy-1,1,3,3-tetramethylcyclobutane, 2,2-bis(3-[beta]-hydroxyethoxyphenyl)propane, and 2,2-bis(4-hydroxypropoxyphenyl)propane (DE-A-24 07 674, DE-A-24 07 776, DE-A-27 15 932).

Other polyalkylene terephthalates to be used with preference according to the invention are copolyesters which are prepared from at least two of the abovementioned acid components and/or from at least two of the abovementioned alcohol components, and/or 1,4-butanediol. Particularly preferred copolyesters are poly(ethylene glycol/1,4-butanediol) terephthalates.

The thermoplastic polyesters to be used according to the invention as component A can also be used in a mixture with other polyesters and/or with further polymers.

The inventive polycarbonates (component B) to be used are reaction products of phosgene with diols, preferably with diphenols.

Polycarbonates are glass-clear, can be colored, can be welded, and can be adhesive-bonded, and are moreover highly dimensionally stable, and have high impact resistance. They are therefore used for injection-molded items, for example for the production of CDs and insulation foils.

Examples of preferred diphenols are 4,4′-dihydroxybiphenyl (DOD), 2,2-bis(4-hydroxyphenyl)propane (bisphenol A), 1,1-bis(4-hydroxyphenyl)-3,3,5-trimethylcyclohexane (bisphenol TMC), 1,1-bis(4-hydroxyphenyl)cyclohexane, 2,4-bis(4-hydroxyphenyl)-2-methylbutane, 1,1-bis(4-hydroxyphenyl)-1-phenylethane, 1,1-bis(4-hydroxyphenyl)-p-diisopropylbenzene, 1,3-bis[2-(4-hydroxyphenyl)-2-propyl]benzene (bisphenol M), 2,2-bis(3-methyl-4-hydroxyphenyl)propane, 2,2-bis(3-chloro-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 2,2-bis(3,5-dichloro-4-hydroxyphenyl)propane, and 2,2-bis(3,5-dibromo-4-hydroxyphenyl)propane.

Examples of particularly preferred diphenols are 2,2-bis(4-hydroxyphenyl)propane (bisphenol A), 1,3-bis[2-(4-hydroxyphenyl)-2-propyl]benzene (bisphenol M), 2,2-bis(3,5-dimethyl-4-hydroxyphenyl)propane, 1,1-bis(4-hydroxyphenyl)-1-phenylethane, 2,2-bis(3,5-dichloro-4-hydroxyphenyl)propane, 2,2-bis-(3,5-dibromo-4-hydroxyphenyl)propane, 1,1-bis(4-hydroxyphenyl)cyclohexane, and 1,1-bis(4-hydroxyphenyl)-3,3,5-trimethylcyclohexan (bisphenol TMC).

The diphenols can be used either alone or else in a mixture with one another; homopolycarbonates and copolycarbonates are included. The diphenols are known from the literature or can be prepared by processes known to the literature (see, for example, H. J. Buysch et al., Ullmann's Encyclopedia of Industrial Chemistry, VCH, New York 1991, 5th edn., vol. 19, p. 348).

It is particularly preferable that component D is melamine polyphosphate.

It is particularly preferable according to the invention to use mineral particulate fillers based on talc, wollastonite, kaolin and/or glass fibers.

Particularly for applications in which isotropy of dimensional stability and high thermal dimensional stability are demanded, for example in motor vehicle applications for exterior body work parts, it is preferable to use mineral fillers, particularly talc, wollastonite, or kaolin.

Acicular mineral fillers can moreover be used with particular preference as Component E. Acicular mineral fillers are according to the invention mineral fillers having pronounced acicular character. Acicular wollastonites are an example that may be mentioned. The length:diameter ratio of the mineral is preferably from 2:1 to 35:1, particularly preferably from 3:1 to 19:1, most preferably from 4:1 to 12:1. The average particle size of the inventive suitable acicular minerals is preferably smaller than 20 microns, particularly preferably smaller than 15 microns, with particular preference smaller than 10 microns.

The filler and/or reinforcing material can, if appropriate, have been surface-modified, for example using a coupling agent or coupling agent system, e.g. based on silane. However, the pretreatment is not essential. Particularly when glass fibers are used, it is also possible to use polymer dispersions, film-formers, branching agents, and/or glass fiber-processing aids, in addition to silanes.

The form in which the glass fibers to be used with particular preference according to the invention, if appropriate, as component E are added is that of continuous-filament fibers or of chopped or ground glass fibers, and the fiber diameter of these is generally from 7 to 18 microns, preferably from 9 to 15 microns. The fibers can have been equipped with a suitable size system and with a coupling agent or coupling agent system, e.g. based on silane.

Preferred coupling agents are silane compounds from the group of aminopropyltrimethoxysilane, aminobutyltrimethoxysilane, aminopropyltriethoxysilane, aminobutyltriethoxysilane, and the corresponding silanes which contain a glycidyl group as substituent X.

The amounts generally used of the silane compounds for surface-coating for modification of the fillers are from 0.05 to 2% by weight, preferably from 0.25 to 1.5% by weight, and in particular from 0.5 to 1% by weight, based on the mineral filler.

The processing to give the molding composition or to give the molding can cause the d97 or d50 value of the particulate fillers in the molding composition or in the molding to be smaller than that of the fillers originally used. The processing to give the molding composition or to give the molding can cause the length distributions of the glass fibers in the molding composition or in the molding to be shorter than those originally used.

In another alternative preferred embodiment, the molding compositions can comprise, as component F, in addition to components A to E), at least one lubricant and mold-release agent. Examples of materials suitable for this purpose are long-chain fatty acids (e.g. stearic acid or behenic acid), salts thereof (e.g. Ca stearate or Zn stearate), and also the ester derivatives or amide derivatives thereof (e.g. ethylenebisstearylamide), montan waxes (mixtures composed of straight-chain, saturated carboxylic acids whose chain lengths are from 28 to 32 carbon atoms) and also low-molecular-weight polyethylene waxes and low-molecular-weight polypropylene waxes. It is preferable according to the invention to use lubricants and/or mold-release agents from the group of the low-molecular-weight polyethylene waxes, and also the esters of saturated or unsaturated aliphatic carboxylic acids having from 8 to 40 carbon atoms with saturated aliphatic alcohols having from 2 to 40 carbon atoms, and very particular preference is given here to pentaerythritol tetrastearate (PETS).

In another alternative preferred embodiment, the molding compositions can also comprise further additives, in addition to components A to E. Examples of conventional additives are stabilizers (e.g. UV stabilizers, heat stabilizers, gamma-ray stabilizers, hydrolysis stabilizers), antistatic agents, further flame retardants, emulsifiers, nucleating agents, plasticizers, processing aids, impact modifiers, dyes, and pigments. The additives can be used alone or in a mixture or in the form of masterbatches, or can be admixed in advance with component A) in the melt, or applied to the surface thereof.

Examples of stabilizers that can be used are sterically hindered phenols and/or phosphites, hydroquinones, aromatic secondary amines, such as diphenylamines, substituted resorcinols, salicylates, benzotriazoles, and benzophenones, and also various substituted representatives of these groups, or a mixture of these.

Suitable UV stabilizers that may be mentioned are various substituted resorcinols, salicylates, benzotriazoles, and benzophenones.

Impact modifiers (elastomer modifiers, modifiers) are very generally copolymers preferably composed of at least two of the following monomers: ethylene, propylene, butadiene, isobutene, isoprene, chloroprene, vinyl acetate, styrene, acrylonitrile, and acrylic or methacrylic esters having from 1 to 18 carbon atoms in the alcohol component.

Colorants which may be added are inorganic pigments, such as titanium dioxide, ultramarine blue, iron oxide, zinc sulfide, and carbon black, and also organic pigments, such as phthalocyanines, quinacridones, and perylenes, and also dyes, such as nigrosin, and anthraquinones, and also other colorants. For the purposes of the present invention, use of carbon black is preferred.

Examples of nucleating agents that can be used are sodium phenylphosphinate, calcium phenylphosphinate, aluminum oxide, or silicon dioxide, and also preferably talc.

Examples of processing aids that can be used are copolymers composed of at least one [alpha]-olefin with at least one methacrylic ester or acrylic ester of an aliphatic alcohol. Preference is given here to copolymers in which the [alpha]-olefin is composed of ethene and/or propene and the methacrylic ester or acrylic ester contains, as alcohol component, linear or branched alkyl groups having from 4 to 20 carbon atoms. Particular preference is given to butyl acrylate and 2-ethylhexyl acrylate.

Examples that may be mentioned of plasticizers are dioctyl phthalate, dibenzyl phthalate, butyl benzyl phthalate, hydrocarbon oils, and N-(n-butyl)benzenesulfonamide.

The term “phosphinic salt” hereinafter encompasses salts of phosphinic and of diphosphinic acid, and polymers thereof.

The phosphinic salts prepared in an aqueous medium are in essence monomeric compounds. As a function of the reaction conditions, polymeric phosphinic salts can sometimes also be produced.

Examples of suitable phosphinic acids as constituent of the phosphinic salts are:

dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methylphenylphosphinic acid, and diphenylphosphinic acid.

The salts of the phosphinic acids according to the invention can be prepared by known methods, described in some detail by way of example in EP-A-699 708. The phosphinic acids here are by way of example reacted in aqueous solution with metal carbonates, with metal hydroxides, or with metal oxides.

The abovementioned phosphinic salts can be used in various physical forms for the inventive compounded polyester materials, as a function of the polymer used and of the properties desired. By way of example, the phosphinic salts can be milled to give a fine-particle form in order to achieve better dispersion in the polymer. It is also possible, if desired, to use a mixture of various phosphinic salts.

The phosphinic salts according to the invention are thermally stable, and neither decompose the polymers during processing nor affect the preparation process for the plastics molding composition. The phosphinic salts are non-volatile under the usual conditions for preparation and processing of polyesters.

An example of the method for incorporating components C and D into thermoplastic polyesters premixes all of the constituents in the form of powder and/or pellets in a mixer and then homogenizes them in the polymer melt in a compounding assembly (e.g. a twin-screw extruder). The melt is usually drawn off in the form of a strand, cooled, and pelletized. It is also possible to introduce components C and D separately by way of a metering system directly into the compounding assembly.

It is likewise possible to admix the flame-retardant additives C and D with finished polymer pellets or with finished polymer powder, and to process the mixture directly in an injection-molding machine to give moldings.

In the case of polyesters by way of example, the flame-retardant additives C and D can also be added to the polyester composition before the polycondensation process has been completed.

The flame-retardant compounded polyester materials are suitable for the production of moldings, of films, of filaments, or of fibers, e.g. via injection molding, extrusion, or pressing.

Particular preference is given according to the invention to combinations which comprise

from 30 to 64.9% by weight of polyester
from 3 to 15% by weight of polycarbonate,
from 8 to 20% by weight of the Zn, Ti, and/or Al salts of diethylphosphinic acid and/or of methylethylphosphinic acid,
from 8 to 20% by weight of melamine polyphosphate,
from 16 to 35% by weight of glass fibers, and
from 0.1 to 1% by weight of lubricant.

### EXAMPLES

### 1. Components Used

### Commercially Available Polyester (Pellets), Component A:

Polybutylene terephthalate (PBT): Ultradur® 4500 (BASF, Germany)

### Commercially Available Polycarbonate (Pellets), Component B:

### Makrolon® 2805 (Bayer Material Science, Germany)

### Component C:

Aluminum salt of diethylphosphinic acid, hereinafter termed Depal. Zinc salt of diethylphosphinic acid, hereinafter termed Depzn.

### Component D:

Melapur® 200/70 (melamine polyphosphate), Ciba Specialty Chemicals, Switzerland

### Component E:

Vetrotex® EC 10 P 952 (glass fibers), Vetrotex Reinforcement, Germany

### Component F:

Lubricant: Licolub® FA1, montan wax, Clariant, Switzerland

### 2. Preparation, Processing, and Testing of Flame-Retardant Compounded Polyester Materials

The flame retardant components were mixed in the ratios stated in the tables with the polymer pellets and with any additives, and incorporated at temperatures of from 240 to 280° C. in a twin-screw extruder (Leistritz ZSE 27 HP-44D). The homogenized polymer strand was drawn off, cooled in a water bath, and then pelletized.

After adequate drying, the molding compositions were processed to give test specimens in an injection-molding machine (Arburg 320C/KT) at melt temperatures of from 260 to 280° C. The flame retardancy of the molding compositions was determined by the UL 94 V method (Underwriters Laboratories Inc. Standard of Safety, “Test for Flammability of Plastic Materials for Parts in Devices and Appliances”, p. 14 to p. 18 Northbrook 1998).

Glow-wire resistance was determined on the basis of the GWFI (Glow-Wire Flammability-Index) test to IEC 60695-2-12, and also by the GWIT (Glow-Wire-Ignition-Temperature) test to IEC 60695-2-13. In the GWFI test, a glowing wire at temperatures of from 550 to 960° C. is used on 3 test specimens (for example plaques whose dimensions are 60×60×1.5 mm) to determine the maximum temperature at which an afterflame time of 30 seconds is not exceeded and no burning drips come from the specimen. In the GWIT test, a comparable test procedure is used and the glow wire ignition temperature is stated, this being higher by 25K (30K at from 900° C. to 960° C.) than the maximum glow-wire temperature that does not lead to ignition, even during the time of exposure to the glowing wire, in 3 successive tests. Ignition is defined here as a flame whose flame time is >=5 sec.

TABLE 1
Addition of polycarbonate to PBT GF 30
using Depal and melamine polyphosphate

| | | Example | | |
|---|---|---|---|---|
| | | 1 | 2 | 3 |
| PBT | (% by wt.) | 50 | 45 | 40 |
| Glass fibers | (% by wt.) | 30 | 30 | 30 |
| Depal | (% by wt.) | 13.3 | 13.3 | 13.3 |
| Melamine | (% by wt.) | 6.7 | 6.7 | 6.7 |
| polyphosphate | | | | |
| PC | (% by wt.) | | 5 | 10 |
| Lubricant | (% by wt.) | 0.3 | 0.3 | 0.3 |
| UL 94 (0.8 mm) | | V-1 | V-0 | V-0 |
| GWIT (1 mm) | (° C.) | 750 | 775 | 775 |
| Tensile strain at | (% by wt.) | 1.9 | 2.2 | 2.0 |
| break | | | | |
| IR at RT | (kJ/m²) | 36 | 37 | 43 |
| NIR at RT | (kJ/m²) | 6.2 | 5.6 | 6.4 |

IR = impact resistance;
NIR = notched impact resistance

TABLE 2
Addition of polycarbonate to PBT GF 30
using Depzn and melamine polyphosphate

| | | Example | | |
|---|---|---|---|---|
| | | 4 | 5 | 6 |
| PBT | (% by wt.) | 50 | 45 | 40 |
| Glass fibers | (% by wt.) | 25 | 25 | 25 |
| Depzn | (% by wt.) | 12.5 | 12.5 | 12.5 |
| Melamine polyphosphate | (% by wt.) | 12.5 | 12.5 | 12.5 |
| PC | (% by wt.) | | 5 | 10 |
| Lubricant | (% by wt.) | 0.3 | 0.3 | 0.3 |
| UL 94 (0.8 mm) | | V-1 | V-0 | V-0 |
| GWIT (1 mm) | (° C.) | 750 | 775 | 775 |
| Tensile strain at break | (% by wt.) | 2.1 | 2.3 | 2.3 |
| IR at RT | (kJ/m²) | 36 | 37 | 43 |
| NIR at RT | (kJ/m²) | 6.2 | 5.6 | 6.4 |

IR = impact resistance;
NIR = notched impact resistance

Examples 1 and 4 are comparative examples, which show that UL 94 V-0 is not achieved at 0.8 mm and that GWIT is only 750° C. Tensile strain at break is in some cases also below 2%.

Addition of from 5 to 10% by weight of polycarbonate according to the invention achieves reliable V-0 classification, increases GWIT to 775° C., and improves tensile strain at break.

1. A flame-retardant compounded polyester material, comprising, as component A, from 40 to 64.9% by weight of a thermoplastic polyester, as component B, from 5 to 10% by weight of a polycarbonate, as component C, from 10 to 15% by weight of a phosphinic salt of the formula (I), diphosphinic salt of the formula (II), a polymer of the phosphinic salt, a polymer of the diphosphinic salt or a mixture thereof, 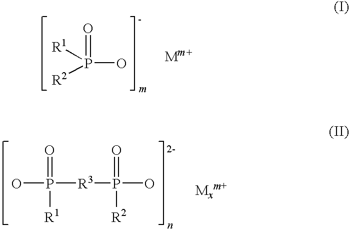
wherein
R¹ and R² are identical or different and are H or C₁-C₆-alkyl, linear or branched, or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, or a protonated nitrogen base;
m is from 1 to 4; n is from 1 to 4; and x is from 1 to 4,
as component D, from 5 to 10% by weight of at least one melamine polyphosphate, as component E, from 15 to 30% by weight of at least one reinforcing material, and, as component F, from 0.1 to 2% by weight of at least one additive, where the total of the components by weight is 100% by weight.

2. The flame-retardant compounded polyester material as claimed in claim 1, wherein R¹ and R² are identical or different and are methyl, ethyl, n-propyl, isopropyl, n-butyl, tert-butyl, n-pentyl or phenyl.

3. The flame-retardant compounded polyester material as claimed in claim 1, wherein R³ is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene, or phenylbutylene.

4. The flame-retardant compounded polyester material as claimed in claim 1, wherein the at least one reinforcing material is a mineral particulate filler based on talc, mica, silicate, quartz, titanium dioxide, wollastonite, kaolin, amorphous silicas, magnesium carbonate, chalk, feldspar, barium sulfate or a combination thereof.

5. The flame-retardant compounded polyester material as claimed in claim 1, wherein the at least one additive is glass fibers.

6. The flame-retardant compounded polyester material as claimed in claim 1, further comprising at least one carbodiimide.

7. The flame-retardant compounded polyester material as claimed in claim 1, wherein the at least one additive is selected from the group consisting of lubricants, mold-release agents or a combination thereof and wherein the lubricants, mold-release agents or a combination thereof are long-chain fatty acids, salts thereof, ester derivatives, amide derivatives thereof, montan waxes, low-molecular-weight polyethylene waxes, low-molecular-weight polypropylene waxes or a combination thereof.

8. A process for the production of a flame-retardant compounded polyester material comprising the step of mixing components A to F as claimed in claim 1, via melt extrusion.

9. A fiber, a foil, or a molding, comprising a flame-retardant compounded polyester material as claimed in claim 1.

10. A medicine, motor vehicle, aircraft, ship, spacecraft, office equipment, article or building comprising a fiber foil or molding as claimed in claim 9.
